(19) United States
(12) Patent Application Publication
(10) Pub. No.: US 2002/0095509 A1
(43) Pub. Date: Jul. 18, 2002

(54) Streaming booster and the method thereof

(75) Inventor: Joe Fan, West Vancouver (CA)

Correspondence Address: Dougherty & Troxell, ONE SKYLINE PLACE, 5205 LEESBURG PIKE, SUITE 1404, FALLS CHURCH, VA, 22041, US

(73) Assignee: World Channel Inc.

(21) Appl. No.: 09/760,759

(22) Filed: Jan. 17, 2001

(51) Int. Cl. G06F 15/16

(52) U.S. Cl. 709/231

(57) ABSTRACT

A streaming booster and the method thereof. The streaming booster is in advance installed between a server and a storage device. When the server acquires a request from the customer end. The server builds a channel to the customer end. The streaming booster performs actions of pre-capturing, prediction, and pre-distributing data to a memory (RAM) of the streaming booster so as to speed the read of data and thus to reduce the delay of the storage device. Therefore, a function of real-time accessing is achieved.

### FIELD OF THE INVENTION

The present invention relates to a streaming booster and the method thereof. The streaming booster is in advance installed between a server and a storage device. The streaming booster performs actions of pre-capturing, prediction, and pre-distributing data to a memory (RAM) therein. When the server acquires a request from the customer end, the server builds a channel to the customer end. The present invention can be applied to a video on demand (VOD) device or other network multimedia systems so that a real time accessing can be achieved between users and storage of the server.

### BACKGROUND OF THE INVENTION

With the improvement of technology, data amount in the multimedia applications are more and more large. How to access a large amount of data and how to access by many users are an serious problem necessary to be resolved. In the case of a video on demand (VOD), it is an application combining a network function with a computer video device. The user may be connected to a server of a video provider through a computer network. After browsing and checking, the required video is sent back to the customer end. From the viewpoint of function, VOD is a service by which a program can be selected and controlled (playing, stopping, backward, fast rotation, etc). Therefore, the transformation of a great deal of data is required so that the bandwidth and system resource is wasted greatly.

In order to resolve the problem of data accessing and accessing by many users, the manufactures put a great effort to the development of software, network accessing, and data compression. For example, the improvement of MPEG format is developed so that MPEG2, MPEG4, and others are disclosed for improving the management of multimedia data. In that, the distribution, replication and storage hierarchy are used for the application of combining a database to a network.

From the application field of VOD, a great problem is to the real-time reaction to the demands of the system users. Furthermore, from the viewpoint of a designer, how to efficient using system resource and increase data flow or reduce the requirement of memories so as to reduce the cost are eagerly problems and necessary to be resolved.

From the topics of real-time reaction, MPEG is a current used multimedia standard. In the MPEG format, I frame is an input point of a multimedia file. P frame is an advance prediction point and B frame is a bi-directional prediction point. However, these points are real-timed only for current objects. If they are left from the current object, then the storage device must be read again. The encoding of the B frame is decoded by the known I frame and I′ frame. The bi-directional prediction of the B frame needs the previous and succeeding reference frame. Therefore, the problem of real-time does not be completely resolved.

Another, recently, the manufacturer dedicates all the effort to the improvement of network systems, especially to the management of a continuous multimedia data. For example, the distribution, replication and storage hierarchy are used for the application of combining a database to a network.

The presentation of continuous multimedia data is combined with more than one data flow and thus, a large storage device is necessary. Moreover, the accessing rate of the storage device must be very high. Therefore, how to select a hardware is an important consideration. Although, a buffered data can be stored in the memory of the storage device or the memory of the server, but this only provides a very small time difference. The schedule that the data send to an application system is very important. Therefore, the management of a continuous multimedia device must be emphasized in integrating a storage device and data transmission. Therefore, the present invention provides a device for speeding a multimedia data flow and the method of same for sharking part of reading action in the storage device. Thus, the mechanic delay in the storage device is reduced so as to achieve a function of real-time accessing.

### SUMMARY OF THE INVENTION

Accordingly, the primary object of the present invention is to provide a method for boosting multimedia data stream. Thereby, a real time accessing can be achieved between the user and manufacturer of the server by the present invention. Therefore, the system resource can be used efficiently and thus, the cost is reduced.

Another object of the present invention is to provide a streaming booster, which is in advance installed between a server and a storage device. When the server acquires a request from the customer end. The server builds a channel to the customer end. The streaming booster performs actions of pre-capturing, prediction, and pre-distributing data to a memory (RAM) therein. The stream booster reads data from the storage device, and then the read data is stored in the memory of the stream booster. A buffer set and channel is formed. Then the data block is sent through the buffers so as to speed the access of data and thus to reduce the delay of streaming from a storage device. Therefore, a function of real-time accessing is achieved.

The aforesaid action of the stream booster is performed under the control of a read only memory (ROM) or software method. The read only memory module is built in the streaming booster or disposed as an external module.

The various objects and advantages of the present invention will be more readily understood from the following detailed description when read in conjunction with the appended drawing.

### BRIEF DESCRIPTION OF THE DRAWINGS

FIG. 1 is a system schematic view of the embodiment in the present invention.

FIG. 2 is a control flow diagram of the embodiment according to the present invention.

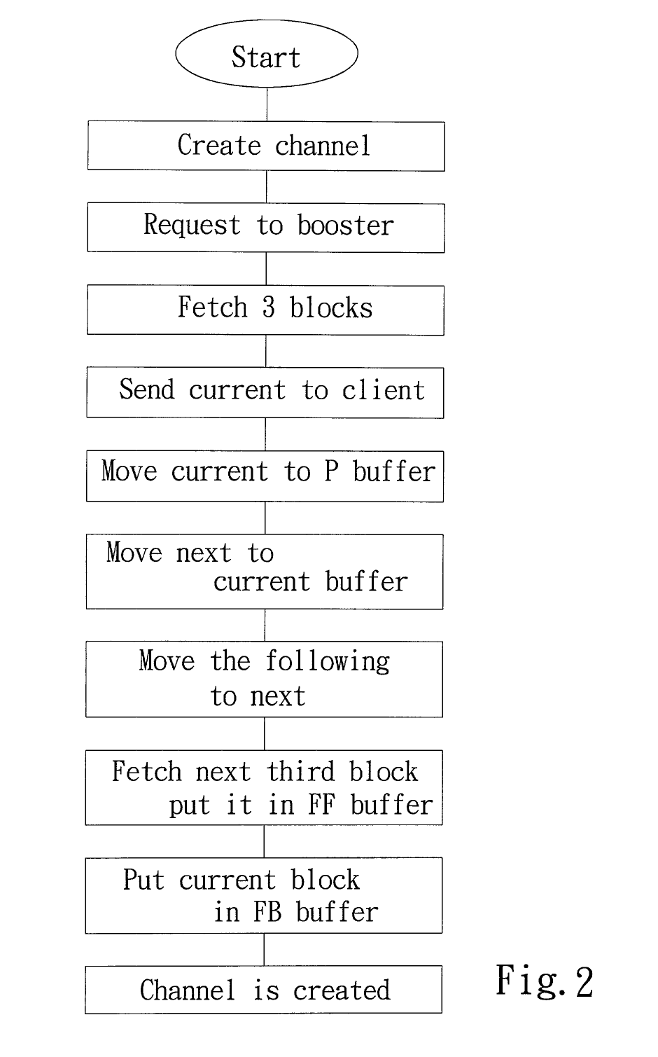

FIG. 3 is a structural view of an embodiment about the stream booster in the present invention.

### DETAILED DESCRIPTION OF THE PREFERRED EMBODIMENTS

The present invention relates to a method and device for boostering the accessing of multimedia data stream (for example, a video on demand). Not only the transferring speed of a multimedia data is increased, but also a real-time assessing is achieved.

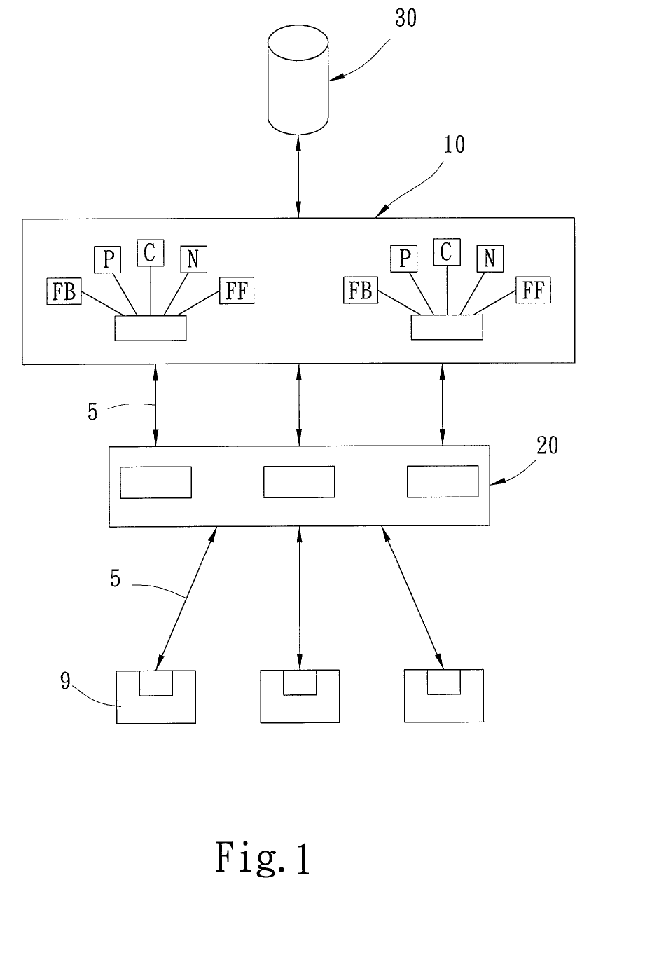

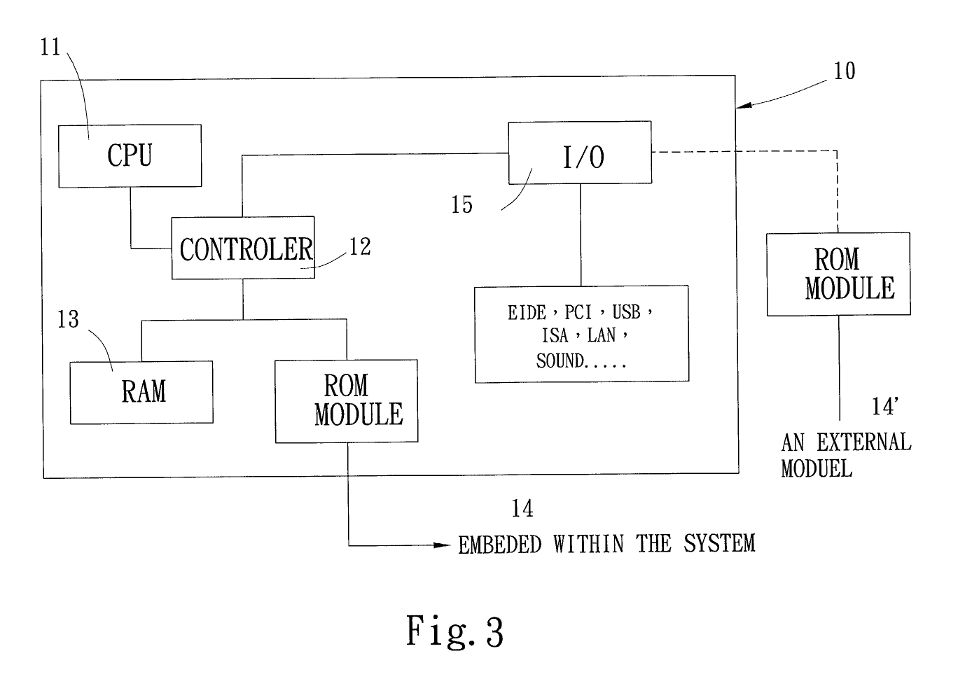

Referring to FIGS. 1 and 3, in the present invention, a streaming booster 30 is in advance installed between a server 20 and a storage device 30. The streaming booster includes at least a CPU 11, a set of memory RAM 13, a controller 12, an I /O 15. A read only memory module (ROM module) 14 or 14′ serves to control the actions of prediction, pre-distribution, and others. The read only memory module can be built in the streaming booster 14 or disposed as an external module 14′.

When the server acquires a request from the customer end 9. The server 20 builds a channel 5 to the customer end. Then, the server request to the storage device 30 through the streaming booster 10. Simultaneously, the streaming booster 10 reads the data blocks of the storage device according to the request of the customer end.

With reference to FIG. 1, the streaming booster 10 read a data block from the storage device 30. Then, the data is placed into a fast forward buffer FF having a first in first out rule. When a first data block is sent to the customer end, the second data block is moved into a current buffer C for being transferred immediately. Meanwhile, a third data block is moved into a next buffer N to be prepared for being sent to the current buffer C. At that time, the fast forward buffer FF has two data blocks just read and a third data block is reading now.

When a first data block is sent from the current buffer C, then the data block is moved to a previous buffer P, and then is further moved to a fast backward buffer FB having a first in later out rule. The data blocks in the previous buffer P and fast backward buffer FB can be returned to the current buffer C according to the request of the customer end and then are sent out. In the performance of fast backward function, the data block read from the storage device 30 are placed in the fast backward buffer FB.

By the aforesaid transmission way of the data block, the multimedia data stream in the storage device is captured, detected and distributed in advanced to the memory of the accessing device. Therefore, the function of reading data directly from the storage device is improved. Not only the transmission speed is increased, but also a real-time accessing is achieved. Furthermore, due to the assist of the streaming booster, in the server, the requirement of a main memory and CPU is reduced so that the system resource can be used beneficially. For example, in general, if a server provides for 30 customer ends on-line, it needs a main memory of at least 512 MB and 2 to 4 CPU. While in the present invention, it is only needs a main memory of 256 MB and a CPU.

The present invention is described by the preferred embodiments. However, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for speeding a multimedia data stream, wherein a streaming booster is in advance installed between a server and a storage device; the streaming booster includes at least a CPU, a set of memory RAM, a controller, a I/O; a read only memory module (ROM module) serves to control various actions; when the server acquires a request from the customer end; the server builds a channel to the customer end; the streaming booster performs actions of pre-capturing, prediction, and pre-distributing data to a memory (RAM) of the streaming booster so as to reduce the delay of streaming from the storage device, therefore, speeding reading action of data and achieve a function of real-time accessing.

2. The method for speeding a multimedia data flow as claimed in claim 1, wherein the read only memory module is built in the streaming booster.

3. The method for speeding a multimedia data stream as claimed in claim 1, wherein the read only memory module is disposed as an external module.

4. The method for speeding a multimedia data stream as claimed in claim 1, wherein the memory (RAM) includes at least one buffer set, each buffer set includes at least one previous buffer, one current buffer, one next buffer, a fast forward buffer operated according to a first in first out rule, and a fast backward buffer operated according to a first in later out rule, the streaming booster reads at least one data block from the storage device and then places the data block into the fast forward buffer; when an first data block is sent to a customer end, a second data block is moved into the current buffer for being sent out immediately; meanwhile, the third data block is moved into a next buffer for being prepared to be moved to the current buffer; at that time, the fast forward buffer has been stored with a new buffer, and is reading a next data block; when a data block is sent from the current buffer, then the data block is moved to a previous buffer, and then is further moved to a fast backward buffer; the data blocks in the previous buffer and fast backward buffer are returned to the current buffer according to a request of the customer end and then are sent out; in the performance of fast backward function, the data block read from the storage device are placed in the fast backward buffer.

5. A streaming booster for speeding a multimedia data flow, wherein the streaming booster is in advance installed between a server and a storage device; the streaming booster includes at least a CPU, a set of memory RAM, a controller, a I/O; a read only memory module (ROM module) serves to control various actions so that data blocks in the streaming booster is read out in advance, pre-detected, and pre-distributed to a memory of the streaming booster so that the server sends data to a customer end through the streaming booster according to a request of the customer end.

6. The streaming booster for speeding a multimedia data flow as claimed in claim 5, wherein the memory (RAM) includes at least one buffer set, each buffer set includes at least one previous buffer, one current buffer, one next buffer, a fast forward buffer according to a first in first out rule, and a fast backward buffer according to a first in later out rule, the streaming booster reads at least one data block from the storage device and then places the data block into the fast forward buffer; when an first data block is sent to a customer end, a second data block is moved into the current buffer for being sent out immediately; meanwhile, the third data block is moved into a next buffer for being prepared to be moved to the current buffer; at that time, the fast forward buffer has been stored with a new buffer, and is reading a next data block; when a data block is sent from the current buffer, then the data block is moved to a previous buffer, and then is further moved to a fast backward buffer; the data blocks in the previous buffer and fast backward buffer are returned to the current buffer according to the request of the customer end and then are sent out; in the performance of fast backward function, the data block read from the storage device are placed in the fast backward buffer.

7. The streaming booster for speeding a multimedia data flow as claimed in claim 5, wherein the read only memory module is built in the streaming booster.

8. The method for speeding a multimedia data flow as claimed in claim 5, wherein the read only memory module is disposed as an external module.

9. The method for speeding a multimedia data stream as claimed in claim 1 or 5, wherein the streaming booster is made as an independent interface card or an independent control device.
